(19) United States
(12) Patent Application Publication
(10) Pub. No.: US 2012/0221771 A1
(43) Pub. Date: Aug. 30, 2012

(54) DATA STORAGE SYSTEM AND DATA MAPPING METHOD OF THE SAME

(75) Inventors: JUNG-YEON YOON, HWASEONG-SI (KR); HYUN UK JUNG, DAEJEON (KR); JIN YEONG KIM, SUWON-SI (KR); SEUNG HO LIM, SUWON-SI (KR)

(73) Assignee: SAMSUNG ELECTRONICS CO., LTD., SUWON-SI (KR)

(21) Appl. No.: 13/404,289

(22) Filed: Feb. 24, 2012

(30) Foreign Application Priority Data
Feb. 25, 2011 (KR) 10-2011-0017363

(51) Int. Cl. G06F 12/00

(52) U.S. Cl. 711/103; 711/E12.008

(57) ABSTRACT

A data mapping method is performed by a memory controller in a data storage system configured to control a nonvolatile memory device having a plurality of channels, where each channel includes a plurality of nonvolatile memories. The data mapping method includes selecting channels of the plurality of channels to be active channels to which data input from a host are written in response to a request from the host, including nonvolatile memories corresponding to each of the active channels in a candidate zone list as active zones, and sequentially writing the data input from the host to the active zones included in the candidate zone list.

### CROSS-REFERENCE TO RELATED APPLICATIONS

A claim of priority under 35 U.S.C. §119 is made to Korean Patent Application No. 10-2011-0017363, filed on Feb. 25, 2011, in the Korean Intellectual Property Office, the entire contents of which are hereby incorporated by reference.

### BACKGROUND

The inventive concept relates to data storage systems, and more particularly, to a data storage system and a data mapping method thereof.

Data storage devices store data using semiconductor memory devices, and particularly, flash memory devices. Such data storage devices generally operate at higher speeds, are more resistant to physical shock, generate less heat or noise, and are smaller and thinner than disc storage media, e.g., hard disc drives, which have come into widespread use.

However, as storage capacities of data storage devices have increased, the number of flash memory devices and the number of controllers for controlling the flash memory devices must also increase. Thus, power consumption of such data storage devices increases proportionally to the number of flash memory devices and controllers. Accordingly, there is a growing need to effectively reduce power consumption of data storage devices, e.g., particularly when handling requests from host devices, without degrading performance.

### SUMMARY

According to an aspect of the inventive concept, there is provided a data mapping method performed by a memory controller configured to control a nonvolatile memory device having a plurality of channels, where each channel includes a plurality of nonvolatile memories. The data mapping method includes selecting channels of the plurality of channels to be active channels to which data input from a host are written in response to a request from the host; including nonvolatile memories corresponding to each of the active channels in a candidate zone list as active zones; and sequentially writing the data input from the host to the active zones included in the candidate zone list.

According to another aspect of the inventive concept, there is provided a data storage system including a nonvolatile memory and a controller. The nonvolatile memory has a plurality of channels, each channel including a plurality of nonvolatile memories to which data input from a host are written. The controller is configured to determine a number of active channels from among the plurality of channels based on requests from the host, to include the plurality of nonvolatile memories of the active channels as active zones in a candidate zone list, and to sequentially write data from the host only to the active zones included in the candidate zone list.

According to another aspect of the inventive concept, there is provided a data storage device including a controller and a nonvolatile memory device. The nonvolatile memory device has a plurality of channels, each channel including a plurality of nonvolatile memories. The controller includes a request queue configured to store requests from a host and to calculate an average number of requests from the host stored over a predetermined time at predetermined time intervals; a processing unit configured to determine a number of active channels from among the plurality of channels based on the calculated average number of requests, and to include the plurality of nonvolatile memories of the active channels as active zones in a candidate zone list; and a memory interface configured to interface with the nonvolatile memory device to enable data from the host to be sequentially written to the active zones included in the candidate zone list.

### BRIEF DESCRIPTION OF THE DRAWINGS

Illustrative embodiments will be more clearly understood from the following detailed description taken in conjunction with the accompanying drawings, in which:

FIG. 1 is a block diagram of a data storage system, according to an embodiment of the inventive concept;

FIG. 2 is a block diagram of a data storage device, according to an embodiment of the inventive concept;

FIG. 3 is a block diagram illustrating structures of the memory I/F and the nonvolatile memory device of FIG. 2, according to an embodiment of the inventive concept;

FIG. 4 is a block diagram illustrating the request queue of FIG. 2, according to an embodiment of the inventive concept.

FIG. 5 is a block diagram for illustrating control of channels of the nonvolatile memory device of FIG. 3, according to an embodiment of the inventive concept;

FIG. 6 is a block diagram illustrating control of a synchronization signal and power respectively applied to the control module and the nonvolatile memory device illustrated in FIG. 5, according to an embodiment of the inventive concept;

FIG. 7 is a diagram illustrating a conventional static zone mapping method for a comparative example of the inventive concept;

FIGS. 8A and 8B are diagrams illustrating dynamic zone mapping methods, according to embodiments of the inventive concept;

FIG. 9 is a flowchart illustrating a method for data mapping, according to an embodiment of the inventive concept;

FIG. 10 is a block diagram of an electronic system including a data storage device, according to embodiments of the inventive concept;

FIG. 11 is a block diagram of an electronic system including a data storage device according to embodiments of the present inventive concept; and

FIG. 12 is a block diagram of a computer system including a data storage device, according to embodiments of the present inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated.

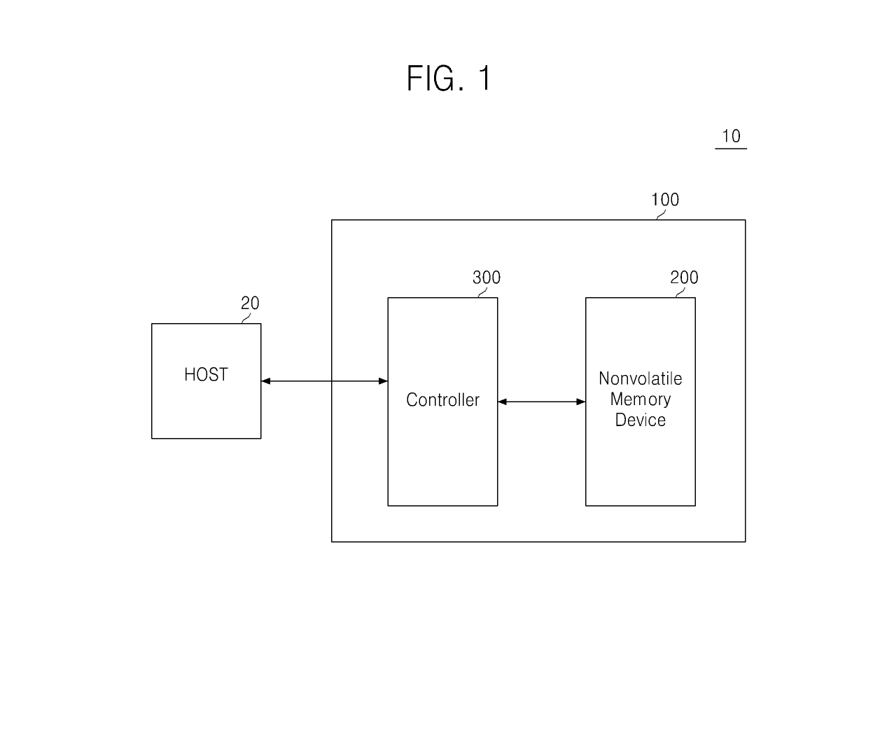

FIG. 1 is a block diagram of a data storage system, according to an embodiment of the inventive concept. Referring to FIG. 1, data storage system 10 includes a data storage device 100 and a host 20. The data storage device 100 includes a controller 300 and a nonvolatile memory device 200.

The host 20 may communicate with the data storage device 100 using an interface protocol, such as peripheral component interconnect-express (PCI-E) protocol, advanced technology attachment (ATA) protocol, serial ATA (SATA) protocol, parallel ATA (PATA) protocol, or serial attached SCSI (SAS) protocol. However, the interface protocol between the host 20 and the data storage device 100 is not restricted to the above examples and may include other interface protocols, such as universal serial bus (USB) protocol, multi-media card (MMC) protocol, enhanced small disk interface (ESDI) protocol, integrated drive electronics (IDE) protocol or the like.

The data storage device 100 may be a solid state drive (SSD) or a memory card (e.g., a secure digital (SD) card or an MMC), for example, but other implementations of the data storage device 100 may be included. The nonvolatile memory device 200 may be a flash memory device, for example, but is not limited to this illustrative configuration. That is, the nonvolatile memory device 200 may include phase-change random access memory (PRAM), magnetoresistive RAM (MRAM), resistive RAM (ReRAM), ferroelectric RAM (FeRAM) or the like. When the nonvolatile memory device 200 is a flash memory device, it may be a NAND flash memory device using floating-gate technology or charge trap flash (CTF) technology, for example. Memory cell transistors may be arranged in two or three dimensions in the nonvolatile memory device 200. In an embodiment, the nonvolatile memory device 200 may include multiple nonvolatile memories, each of which may be a NAND flash memory, for example.

The controller 300 controls overall operations of the data storage device 100, and controls exchange of data between the host 20 and the nonvolatile memory device 200. For example, the controller 300 controls the nonvolatile memory device 200 to write data or read data, in response to a request from the host 20. Also, the controller 300 controls internal operations, e.g., performance control, merging and wear leveling, which are needed for the characteristics of nonvolatile memory device 200 or for efficient management of the nonvolatile memory device 200.

According to an embodiment of the inventive concept, the controller 300 drives firmware and/or software for controlling operations of the nonvolatile memory device 200, which is referred to as a flash translation layer (FTL) (not shown). The controller 300 may control the nonvolatile memory device 200 to control operation of a number of nonvolatile memories from among the multiple nonvolatile memories included in the nonvolatile memory device 200, based on a request from the host 20. This operation of the controller 300 is described in greater detail below.

The nonvolatile memory device 200 provides storage for storing data in a nonvolatile manner. For example, the nonvolatile memory device 200 may store an operating system (OS), various programs, and various data.

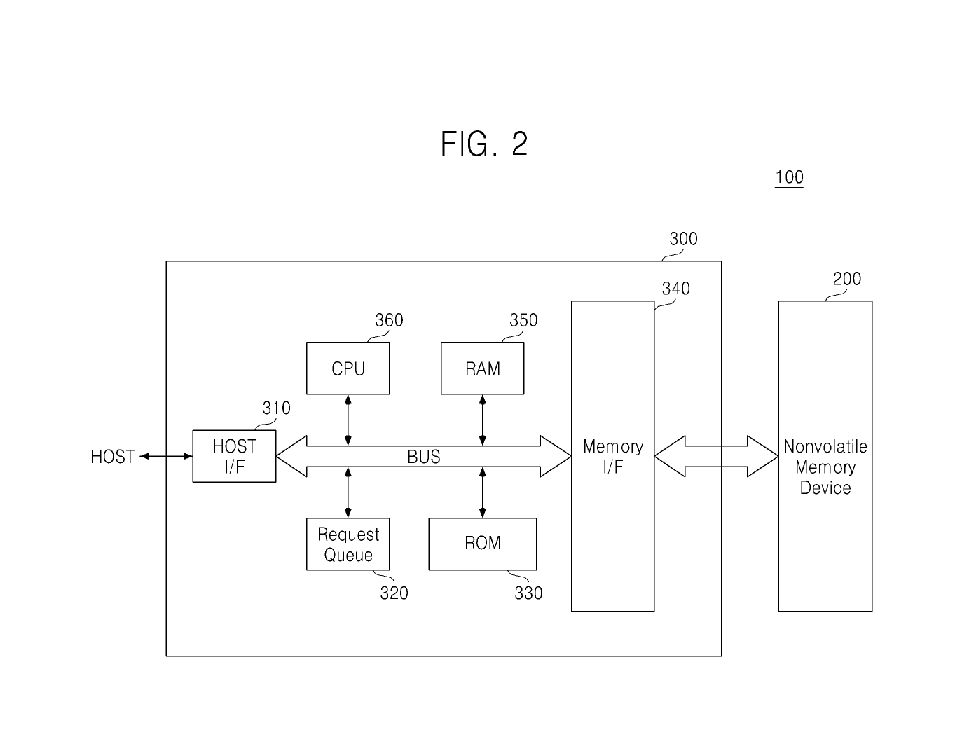

FIG. 2 is a block diagram of the data storage device 100, according to an embodiment of the inventive concept. Referring to FIGS. 1 and 2, the data storage device 100 includes the controller 300 that controls exchange of data between the host 20 and the nonvolatile memory device 200. The controller 300 includes a host interface (I/F) 310, a request queue 320, read only memory (ROM) 330, memory I/F 340, random access memory (RAM) 350, and a central processing unit (CPU) 360. The controller 300 may operate the FTL embodied as software or firmware.

The host interface 310 includes interface protocols as described above to communicate with the host 20. The request queue 320 sequentially stores requests from the host 20, and calculates an average of the number of requests from the host 20 that are stored over a predetermined time, at predetermined time intervals. The ROM 330 stores code data for interfacing with the host 20. The memory I/F 340 interfaces with the nonvolatile memory device 200.

The FTL includes a mapping table (not shown) for performing data mapping operations according to embodiments of the inventive concept. In general, the mapping table is driven in the RAM 350. In the mapping table, multiple logical page numbers (LPNs) are recorded to be respectively mapped to the nonvolatile memories of the nonvolatile memory device 200. According to an embodiment, the nonvolatile memory device 200 is implemented as a NAND flash memory device, in which data is written or read in page units. The LPNs may therefore be used as mapping units, although the inventive concept is not limited to this configuration.

Also, the FTL may control the nonvolatile memory device 200 based on whether a request from the host 20 is a write command or a read command, and may manage the mapping table to be updated whenever the write command or the read command provided by the host 20 is performed on the nonvolatile memory device 200. For example, when a request from the host 20 is a write command, the FTL controls data to be written to one of the nonvolatile memories corresponding to an LPN, and writes the LPN and the corresponding nonvolatile memory in the mapping table. When a request from the host 20 is a read command, the FTL controls data to be read from one of the nonvolatile memories corresponding to an LPN, based on the mapping table.

The RAM 350 may be used as an operating memory of the CPU 360, and may be embodied as dynamic RAM (DRAM), static RAM (SRAM), or the like. Also, the RAM 350 may act as a buffer memory and temporarily store data received from the host 20. The CPU 360 performs overall control operations to write data to or read data from the nonvolatile memory device 200. Also, the CPU 360 may control or otherwise perform operations of the FTL based on requests from the host 20.

Although not shown, according to an embodiment of the inventive concept, the data storage device 100 may further include an error correcting code (ECC) engine. The ECC engine encodes data to be stored in the nonvolatile memory device 200 and decodes data read from the nonvolatile memory device 200.

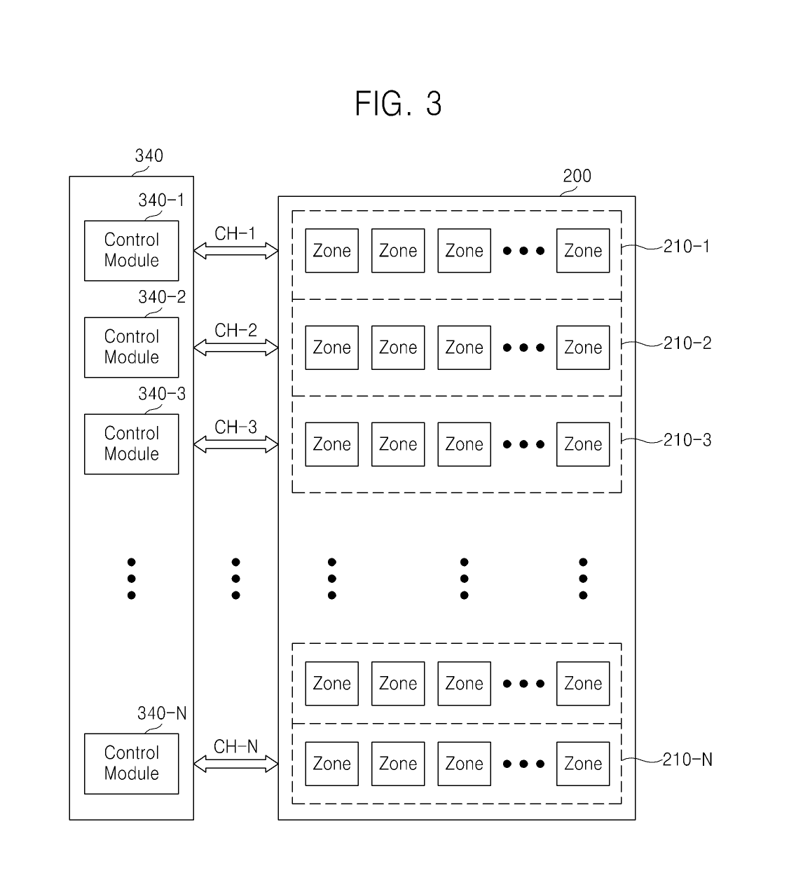

As mentioned above, the nonvolatile memory device 200 may include multiple nonvolatile memories, each of which may be implemented as a NAND flash memory that includes a memory cell array (not shown) consisting of multiple memory cells. An example of the nonvolatile memory device 200 is illustrated in FIG. 3.

FIG. 3 is a block diagram illustrating structures of the memory I/F 340 and the nonvolatile memory device 200 of FIG. 2, according to an embodiment of the inventive concept. Referring to FIGS. 1 to 3, the memory I/F 340 includes multiple control modules 340-1 to 340-N for controlling multiple channels 210-1 to 210-N included in the nonvolatile memory device 200. Each of the channels 210-1 to 210-N included in the nonvolatile memory device 200 includes multiple zones. In an embodiment, each zone may indicate a nonvolatile memory of the multiple nonvolatile memories of the nonvolatile memory device 200, although the embodiments are not limited to this illustrative configuration.

The control modules 340-1 to 340-N included in the memory I/F 340 respectively correspond to the channels 210-1 to 210-N of the nonvolatile memory device 200, for purpose of controlling the nonvolatile memory device 200. For example, the FTL may control the operations of the control modules 340-1 to 340-N corresponding to the channels 210-1 to 210-N in order to control the nonvolatile memory device 200 to activate or deactivate various zones corresponding to the channels 210-1 to 210-N based on requests from the host 20. In this case, the requests from the host 20 may be determined by the request queue 320 before they are handled by the FTL.

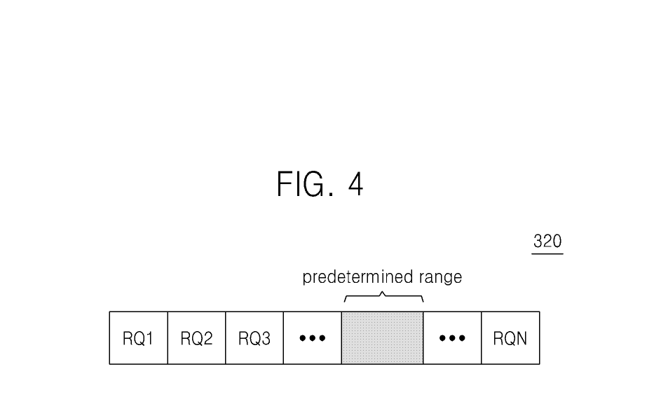

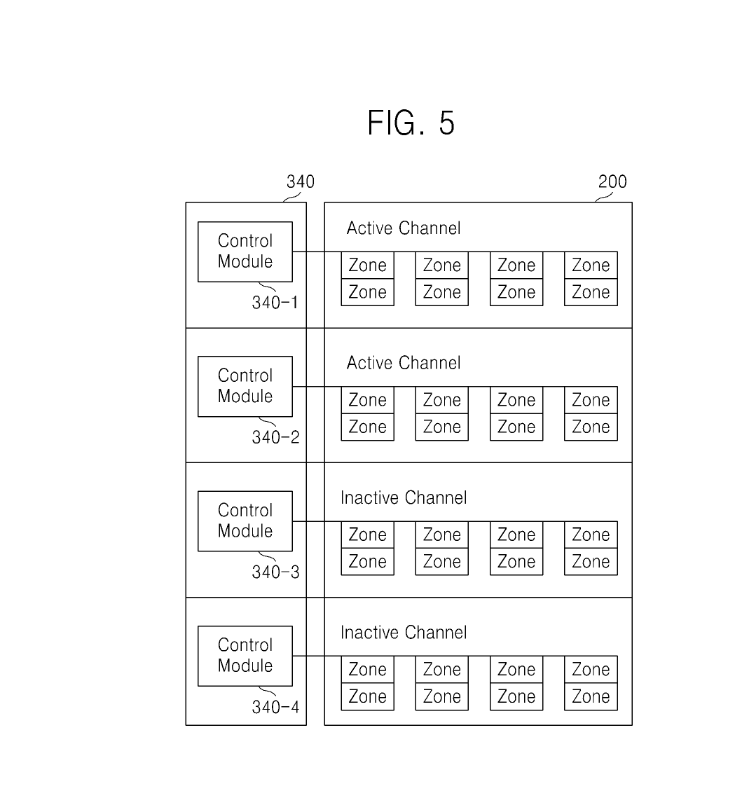

A method of controlling the number of channels of the nonvolatile memory device 200 that are active or inactive based on the number of requests received from the host 20 using the request queue 320, according to an embodiment of the inventive concept, will now be described with reference to FIGS. 4 and 5.

FIG. 4 is a block diagram illustrating an example of the request queue 320 of FIG. 2, according to an embodiment of the inventive concept. FIG. 5 is a block diagram for illustrating control of channels of the nonvolatile memory device 200 of FIG. 3, according to an embodiment of the inventive concept.

Referring to FIGS. 1 to 5, the request queue 320 is a standby queue for handling requests from the host 20, and may include a first request queue RQ1, a second request queue RQ2, . . . , through to an N^{th} request queue RQN. In an embodiment, the request queue 320 is implemented as hardware, but the request queue 320 alternatively may be implemented in whole or part as software. FIG. 5 illustrates an example in which each of the channels of the nonvolatile memory device 200 includes eight zones, although the embodiments are not limited to this illustrative configuration.

The request queue 320 sequentially stores requests from the host 20 in the request queues RQ1, RQ2, . . . , through to RQN. In an embodiment, the request queue 320 calculates an average of the number of requests received from the host 20 and stored over a predetermined time, at predetermined time intervals. The request queue 320 determines that the number of requests from the host 20 is small when the calculated average number is within a predetermined reference range, and determines that the number of requests from the host 20 is large when the calculated average is outside the predetermined reference range. For example, the predetermined reference range may be from zero to a predetermined threshold number, where the calculated average number is within the predetermined reference range when it is at or below the predetermined threshold number, and the calculated average number is outside the predetermined reference range when it is above the predetermined threshold number. In alternative configurations, the request queue 320 may make other determinations regarding the number of requests, such as whether a total number of requests from the host 20 are stored over a predetermined time, and may compare this number to a predetermined reference range, without departing from the scope of the present teachings.

The FTL increases the number of channels that are inactive (“inactive channels”) when the request queue 320 determines that the calculated average number falls within the predetermined reference range, and increases the number of channels that are active (“active channels”) when the calculated average is beyond the predetermined reference range. In other words, the FTL controls the number of inactive channels and/or the number of active channels to correspond to the number of requests from the host 20, based on the determination of the request queue 320.

Here, the active channels are channels from among the channels 210-1 to 210-N that are available for handling requests from the host 20, and the inactive channels are channels from among the channels 210-1 to 210-N that are not available for handling the requests from the host 20. The inactive channels may have already been occupied to handle requests from the host 20 or may be set to be unavailable by the FTL. The zones in the active channels may be referred to as “active zones,” and the zones in the inactive channels may be referred to as “inactive zones.” Active zones may be included in a candidate zone list, and inactive zones may be removed from or otherwise not included in the candidate zone list. Therefore, zones corresponding to an increased number of active channels are added as active zones in the candidate zone list, while zones corresponding to an increased number of inactive channels (if already present in the candidate zone list) are removed from the candidate zone list.

Referring to FIG. 5, in order to activate or deactivate channels and corresponding zones of the nonvolatile memory device 200, based on the determination of the request queue 320, the FTL controls the control modules 340-1 to 340-4 corresponding to the channels of the nonvolatile memory device 200. For example, the FTL may control the number of active/inactive channels based on the determination of the request queue 320 such that a synchronization signal is input to the first and second control modules 340-1 and 340-2 corresponding to active channels of the nonvolatile memory device 200, and the synchronization signal is not input to the third and fourth control modules 340-3 and 340-4 corresponding to inactive channels of the nonvolatile memory device 200. Thus, the control modules 340-1 to 340-N respectively control the channels 210-1 to 210-N of the nonvolatile memory device 200 to be activated or deactivated, accordingly. The FTL may also control applying power (e.g., voltage) to the active channels of the nonvolatile memory device 200 (e.g., corresponding to the first and second control modules 340-1 and 340-2) and not applying power to the inactive channels of the nonvolatile memory device 200 (e.g., corresponding to the third and fourth control modules 340-3 and 340-4).

Of course, active channels and inactive channels from among the multiple channels 210-1 to 210-N included in the nonvolatile memory device 200 may be changed to inactive channels and active channels, respectively, under control of the FTL. Generally, the inactive channels may be easily changed to active channels. However, in an embodiment, the active channels may be changed to inactive channels after writing of data received from the host 20 to the active channels is completed.

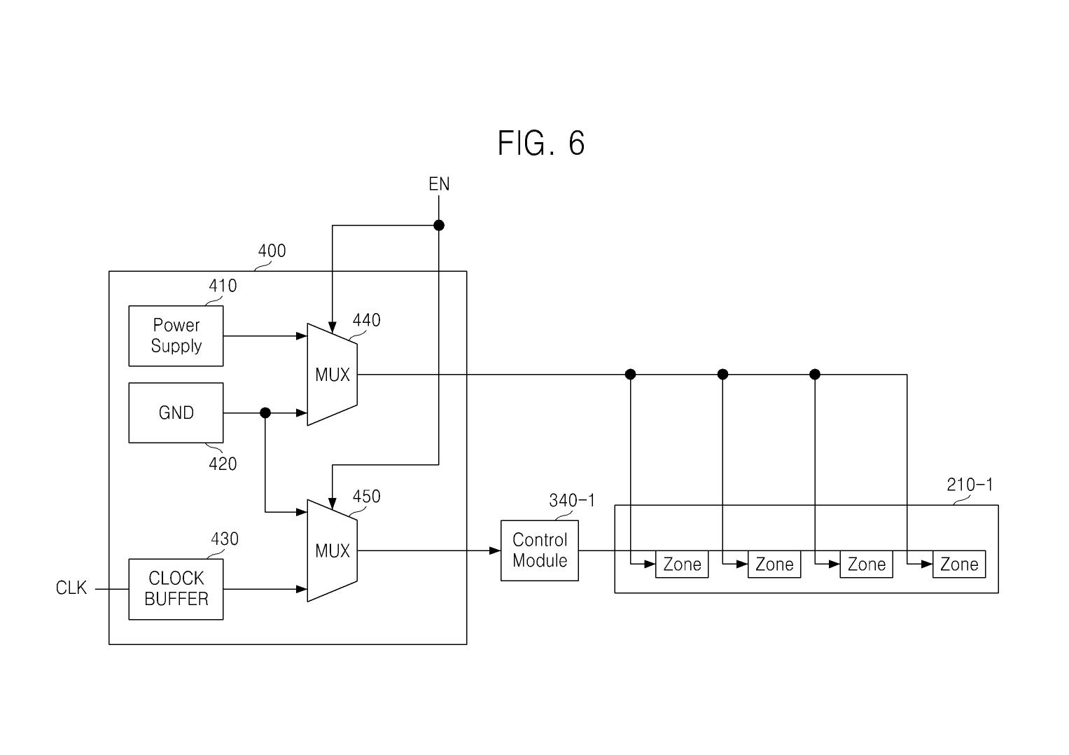

FIG. 6 is a block diagram illustrating control of a synchronization signal and power respectively applied to the control module 340-1 and the nonvolatile memory device 200 illustrated in FIG. 5, according to an embodiment of the inventive concept. For convenience of explanation, FIG. 6 is described with reference to the first control module 340-1 and the first channel 210-1 of the nonvolatile memory device 200 corresponding to the first control module 340-1.

Referring to FIGS. 1 to 6, the data storage system 10 includes a power supply controller 400 configured to control supplying a synchronization signal to the first control module 340-1 and applying power (e.g., voltage) to the first channel 210-1 corresponding to the first control module 340-1. The power supply controller 400 may be disposed in the first control module 340-1 of the memory I/F 340 or may be separately disposed on the data storage system 10.

In the depicted embodiment, the power supply controller 400 includes a power supply device 410, a ground voltage source 420, a clock buffer 430, a first multiplexer 440, and a second multiplexer 450. The power supply device 410 supplies power to the first multiplexer 440 to drive the first channel 210-1 of the nonvolatile memory device 200. The FTL selectively outputs an enable signal EN, e.g., received from the outside, in order to control the first control module 340-1 and the first channel 210-1, based on the determination of the request queue 320 corresponding to the first channel 210-1. For example, the first multiplexer 440 selectively applies power supply voltage from the power supply device 410 and ground voltage from the ground voltage source 420 to the first channel 210-1 based on a value of the enable signal EN. The second multiplexer 450 selectively supplies the synchronization signal from the clock buffer 430, which receives a clock signal CLK, to the first control module 340-1 based on the value of the enable signal EN.

Operation of the first control module 340-1 which drives the first channel 210-1 is controlled based on the synchronization signal output from the second multiplexer 450. Operation of the first channel 210-1 is controlled not only based on the operation of the first control module 340-1, but also according to the voltage output from the first multiplexer 440. The synchronization signal and the voltage are selectively supplied in response to the enable signal EN.

The FTL performs a mapping operation to control the number of active channels and inactive channels from among the multiple channels 210-1 to 210-N included in the nonvolatile memory device 200 based on determinations of the request queue 320 regarding requests from the host 20. Thus, power consumption of the data storage device 100 may be effectively reduced by preventing the voltage from being applied to the inactive channels of the nonvolatile memory device 200, and/or by preventing the synchronization signal from being supplied to the control modules corresponding to the inactive channels.

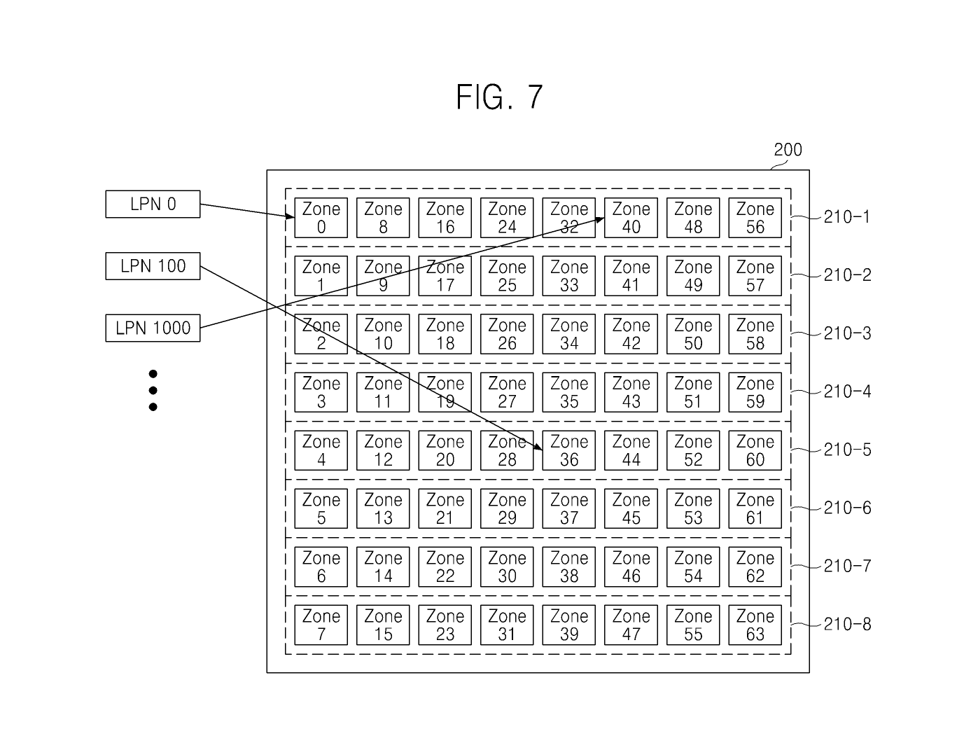

FIG. 7 is a diagram illustrating a static zone mapping method as a comparative example of the inventive concept.

Referring to FIG. 7, the nonvolatile memory device 200 includes zones 0 to 63 included in multiple channels 210-1 to 210-8. FIG. 7 illustrates the nonvolatile memory device 200 as including an 8-channel hardware scheme (channels 210-1 to 210-8), and eight nonvolatile memories (zones) included in each of the channels 210-1 to 210-8, although the comparison may be applicable using other configurations, as well.

In a static zone mapping method, requests from a host (e.g., the host 20 of FIG. 1) are respectively handled using predetermined zones corresponding to logical page numbers (LPNs) in the order in which the requests are input. Thus, multiple zones have been predetermined to handle requests from the host 20. For example, a request from the host 20 corresponding to LPN 0 may be handled using the zone 0, and a request from the host 20 corresponding to LPN 100 may be handled by the zone 36. Therefore, according to the static zone mapping method, the channels 210-1 to 210-8 cannot be controlled such that requests from the host 20 may be handled using other zones, and thus power is applied to all of the channels 210-1 to 210-8. This increases power consumption for driving the data storage device 100 of FIG. 1.

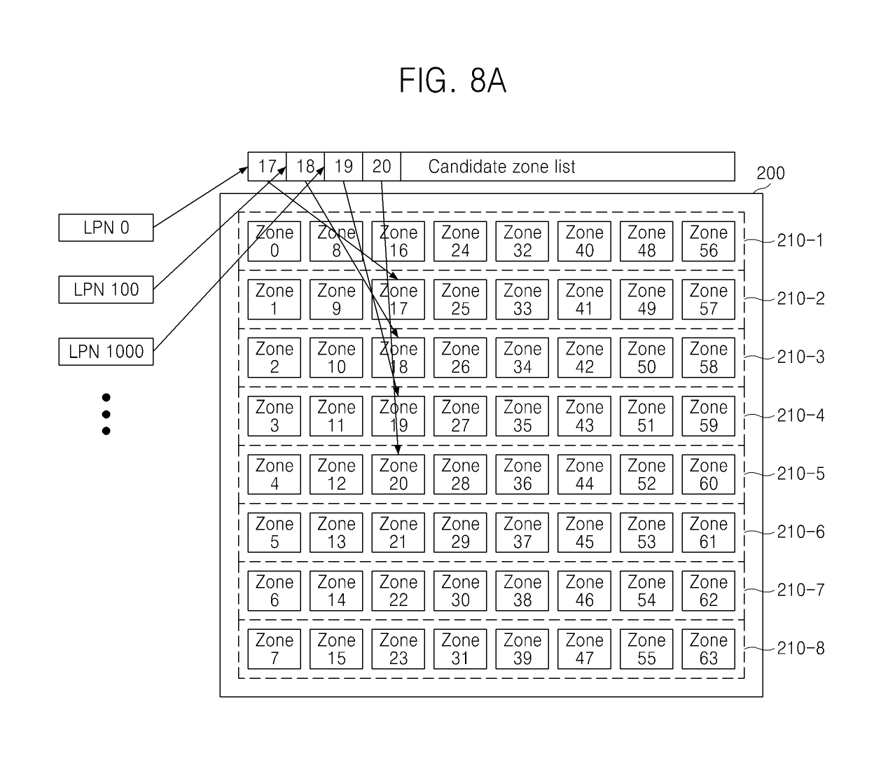

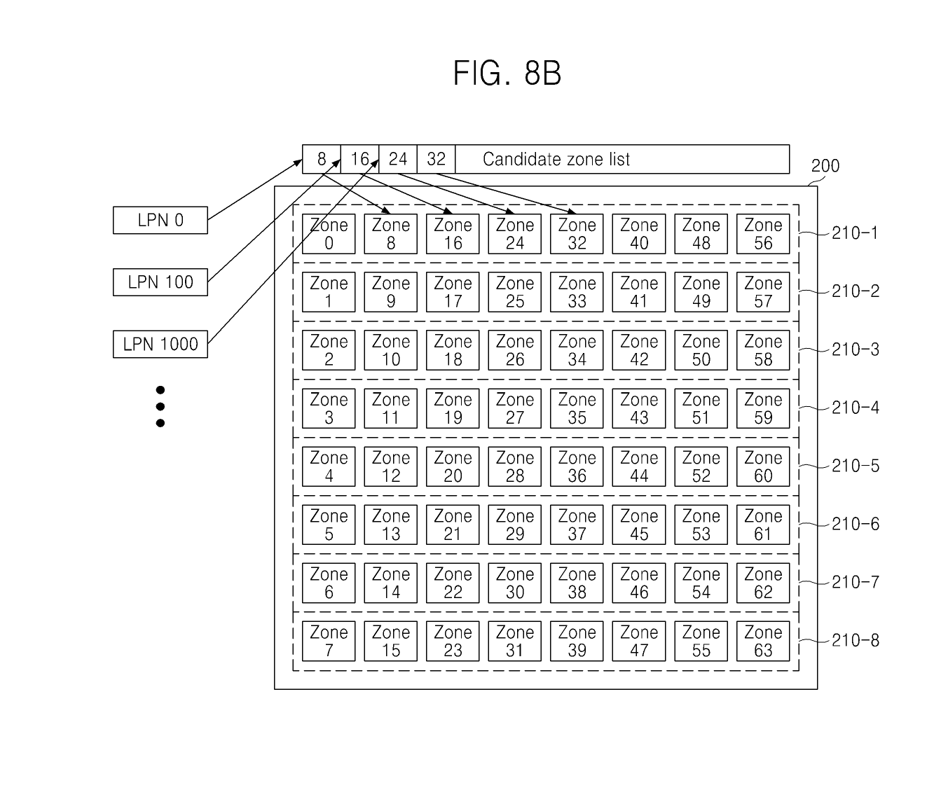

FIGS. 8A and 8B are diagrams illustrating dynamic zone mapping methods, according to embodiments of the inventive concept.

Referring to FIGS. 1 to 6 and 8A, the FTL controls zones corresponding to active channels from among the channels 210-1 to 210-8 of the nonvolatile memory device 200 to be included as active zones in a candidate zone list, based on determinations of the request queue 320 regarding requests from the host 20. Also, the FTL may control the channels 210-1 to 210-8 of the nonvolatile memory device 200 in such a manner that zones included in a channel having a large number of zones from among the zones 0 to 63 that are not in use may be included first in the candidate zone list.

When a request from the host 20 is input to the FTL, the FTL maps the request to a first active zone from among active zones included in the candidate zone list, so that the request may be handled using the first active zone. When a subsequent request is input to the FTL from the host 20, the FTL maps this request to a next active zone from among the active zones included in the candidate zone list. In other words, the FTL sequentially maps requests from the host 20 to the active zones included in the candidate zone list. For example, a request from the host 20 corresponding to the LPN 0 may be handled using zone 17, a request from the host 20 corresponding to the LPN 100 may be handled using zone 18, and a request from the host 20 corresponding to the LPN 1000 may be handled using zone 19. Since the zones 17-19 are in the second to fourth channels 210-2 to 210-4 in the depicted example, the FTL applies power only to the second to fourth channels 210-2 to 210-4 as active channels, and thus the zones included in the second to fourth channels 210-2 to 210-4 may be used as active zones to handle requests from the host 20.

Referring to FIGS. 1 to 6 and 8B, the FTL controls only one channel, e.g., the first channel 210-1, from among the multiple channels 210-1 to 210-8 to be used as an active channel, so that only active zones included in the first channel 210-1 may be used to handle requests from the host 20. For example, when a request from the host 20 is input to the FTL, the FTL maps the request to a first active zone from among active zones included in the candidate zone list, so that the request may be handled using the first active zone. When a subsequent request is input to the FTL from the host 20, the FTL maps this request to a next active zone from among the active zones included in the candidate zone list. For example, a request from the host 20 corresponding to the LPN 0 may be handled using zone 8, a request from the host 20 corresponding to the LPN 100 may be handled using zone 16, and a request from the host 20 corresponding to the LPN 1000 may be handled using zone 24. Since the zones 8, 16 and 24 are in the first channel 210-1 in the depicted example, the FTL applies power only to the first channel 210-1 as an active channel.

When the average of the number of requests from the host 20 calculated by the request queue 320 is beyond a predetermined reference range, for example, the FTL may increase the number of active channels, and the dynamic mapping method of FIG. 8A may thus be used. When the average number of requests from the host 20 calculated by the request queue 320 falls within the predetermined reference range, the FTL may increase the number of inactive channels, and the dynamic mapping method of FIG. 8B may be thus used.

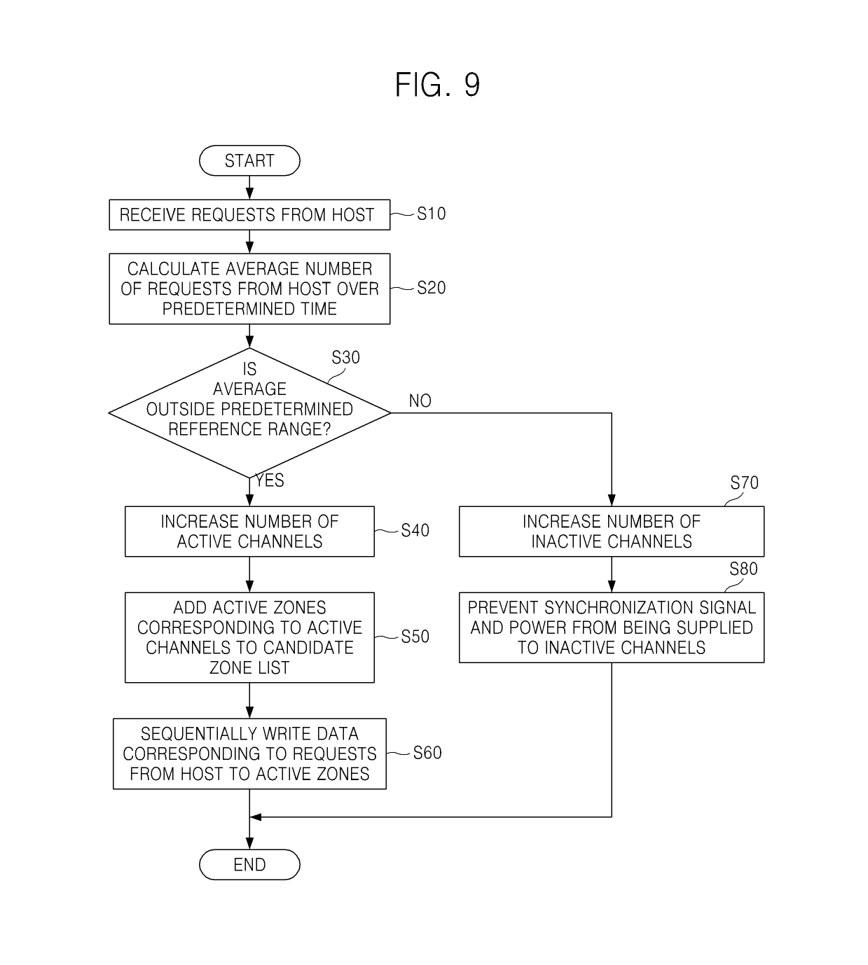

FIG. 9 is a flowchart illustrating a method for data mapping, according to an embodiment of the inventive concept.

Referring to FIGS. 1 to 9, in the data mapping method, requests from the host 20 of FIG. 1 are received in operation S10, and an average number of requests from the host 20 stored over a predetermined time is calculated at predetermined time intervals in operation S20.

It is determined in operation S30 whether the average number calculated in operation S20 falls outside a predetermined reference range. When it is determined that the average number falls outside the predetermined reference range (operation S30: Yes), the number of active channels from among the channels 210-1 to 210-N of the nonvolatile memory device 200 is increased in operation S40. Then, active zones corresponding to the active channels are added to a candidate zone list in operation S50, and data corresponding to the requests from the host 20 are sequentially written to the active zones in operation S60. However, when it is determined in operation S30 that the average number falls within the predetermined reference range (operation S30: No), the number of inactive channels from among the channels 210-1 to 210-N of the nonvolatile memory device 200 is increased in operation S70. Then, synchronization signals and power are prevented from being supplied to the inactive channels in operation S80.

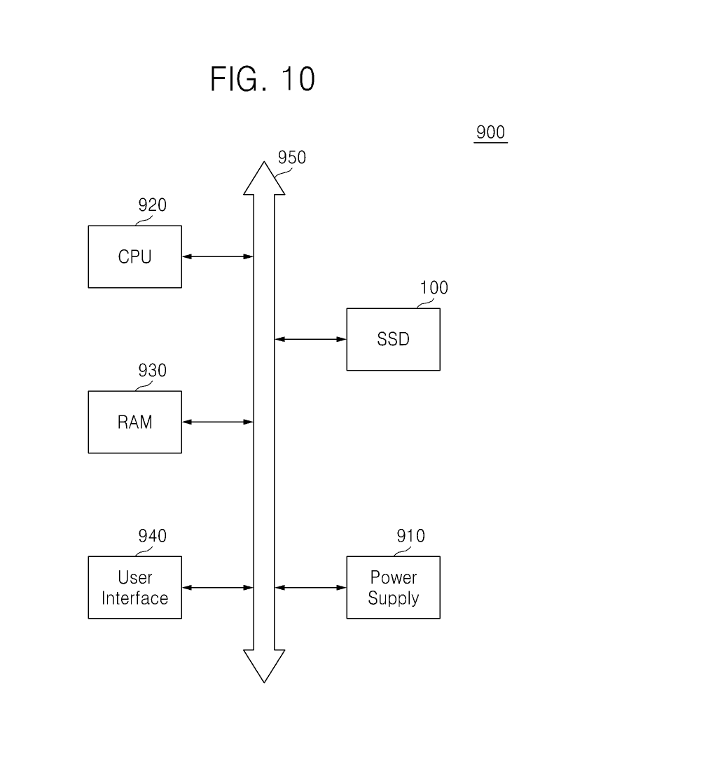

FIG. 10 is a block diagram of an electronic system including a data storage device, according to embodiments of the inventive concept.

Referring to FIG. 10, electronic system 900 includes data storage device 100, a power supply 910, a central processing unit (CPU) 920, a RAM 930, a user interface 940, and a system bus 950 electrically connecting the elements. The CPU 920 controls overall operation of the electronic system 900. The RAM 930 stores information needed for the operation of the electronic system 900. The user interface 940 provides an interface between the electronic system 900 and a user. The power supply 910 supplies electric power to the internal constituent elements, such as the CPU 920, the RAM 930, the user interface 940, and the data storage device 100. The CPU 920 may correspond to the host, and the data storage device 100 may store or read data in response to commands from the host, as described above.

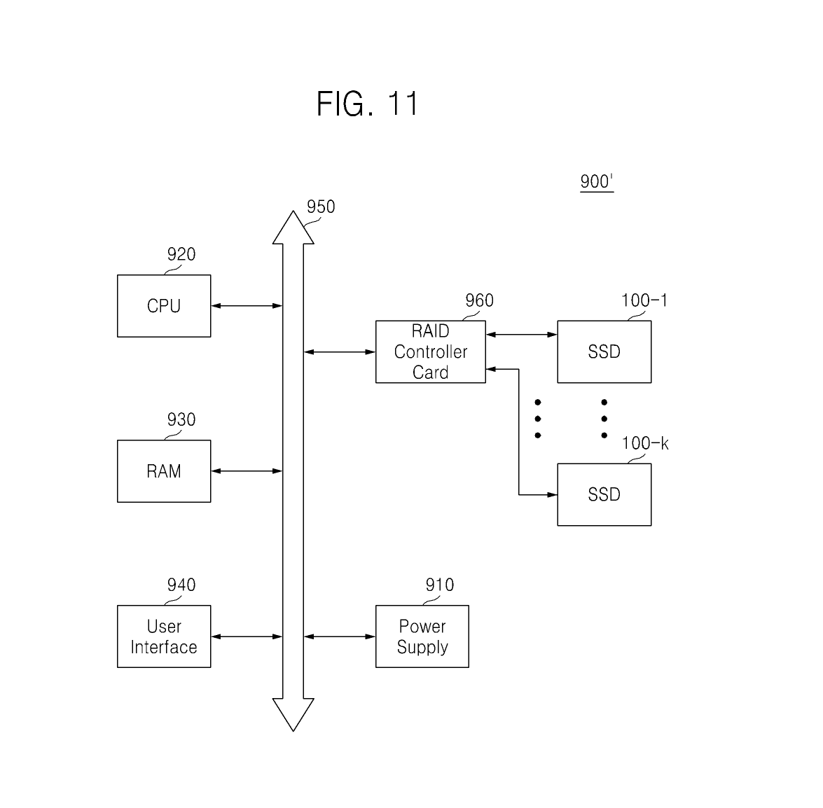

FIG. 11 is a block diagram of an electronic system including a data storage device according to other embodiments of the inventive concept. The electronic system 900′ as illustrated in FIG. 11 has a similar configuration to the electronic system 900 as illustrated in FIG. 10, and therefore only differences between the electronic systems 900 and 900′ will be described.

Referring to FIG. 11, the electronic system 900′ further includes a RAID controller card 960, as compared with the electronic system 900 as illustrated in FIG. 10. The RAID controller card 960 is connected between the host (CPU 920) and the data storage device 100 to control the data storage device 100 in compliance with the host. For example, the data storage device 100 may installed in the RAID controller card 960 and communicate with the host via the RAID controller card 960, in which case, multiple data storage devices 100-1 through 100-k may be installed in the RAID controller card 960. Alternatively, the RAID controller card 960 may be implemented as a separate component from the storage devices 100-1 through 100-k.

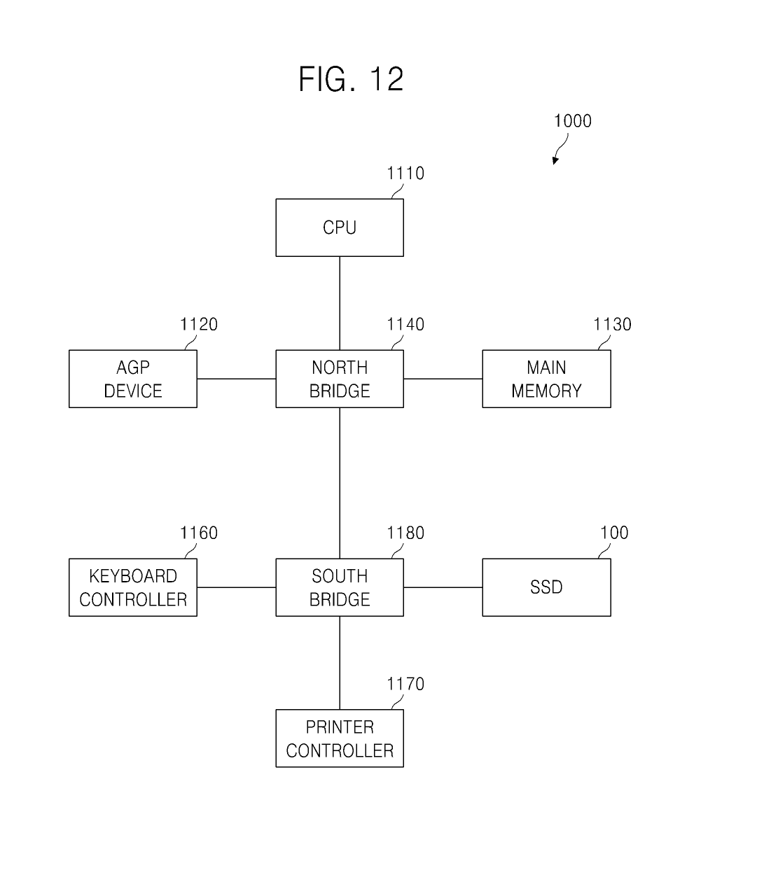

FIG. 12 is a block diagram of a computer system including a data storage device, according to embodiments of the present inventive concept.

Referring to FIG. 12, the computer system 1000 includes computer CPU 1110, as well as an accelerated graphics port (AGP) device 1120 and a main memory 1130 coupled to the computer CPU 1110 via a north bridge 1140. The computer system 1000 further includes a keyboard controller 1160, a printer controller 1170, and the data storage device 100 coupled to the computer CPU 1110 via a south bridge 1180 and the north bridge 1140. Generally, structures and functionalities of the computer CPU 1110, the AGP device 1120, the main memory 1130, the north bridge 1140, the keyboard controller 1160, the printer controller 1170, and the south bridge 1180 of the PC system 1000 would be apparent to one of ordinary skill in the art, and therefore are not described in detail. The computer system maybe a personal computer (PC) system or a notebook computer in which the SSD is used as a main storage device instead of hard disk drive. However, the various embodiments are not restricted to this configuration.

The various embodiments may be embodied as hardware, software, or combinations of hardware and software. Also, the various embodiments may be implemented in whole or in part as computer-readable codes stored on a computer-readable medium. The computer-readable medium may be any data storage device configured to store data as a program executable by a computer system. Examples of the computer-readable medium include read-only memory (ROM), random-access memory (RAM), CD-ROMs, magnetic tapes, floppy disks, and optical data storage devices. The computer-readable medium may also be distributed over network coupled computer systems, so that the computer-readable codes are stored and executed in a distributed fashion. Also, functional programs, codes, and code segments to accomplish the various embodiments may be construed by programmers of ordinary skill in the art to which the present general inventive concept pertains.

Accordingly, in a data storage system and a data mapping method thereof, according to various embodiments, it is possible to dynamically control the number of channels and/or nonvolatile memories that operate based on requests from a host, thereby reducing power consumption of the data storage system.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A data mapping method performed by a memory controller configured to control a nonvolatile memory device comprising a plurality of channels, each channel of the plurality of channels comprising a plurality of nonvolatile memories, the data mapping method comprising:
selecting channels of the plurality of channels to be active channels to which data input from a host are written in response to a request from the host;
including nonvolatile memories corresponding to each of the active channels in a candidate zone list as active zones; and
sequentially writing the data input from the host to the active zones included in the candidate zone list.

2. The data mapping method of claim 1, further comprising:
identifying channels of the plurality of channels that are not active channels as inactive channels; and
excluding nonvolatile memories corresponding to each of the inactive channels from the candidate zone list.

3. The data mapping method of claim 2, further comprising:
sequentially storing requests from the host and calculating an average number of requests from the host stored over a predetermined time; and
determining a number of channels to be selected as the active channels based on the calculated average number of requests.

4. The data mapping method of claim 3, further comprising:
increasing the number of the active channels when the calculated average number of requests is outside a predetermined reference range, wherein active zones corresponding to the increased number of the active channels are included in the candidate zone list.

5. The data mapping method of claim 3, further comprising:
increasing the number of the inactive channels when the calculated average number of requests is within a predetermined reference range, wherein active zones corresponding to the increased number of the in active channels are removed from the candidate zone list.

6. The data mapping method of claim 3, further comprising:
supplying a synchronization signal to control modules corresponding to the active channels, and supplying power to the nonvolatile memories corresponding to the active channels in response to an enable signal based on the calculated average number of requests.

7. The data mapping method of claim 3, further comprising:
preventing supply of a synchronization signal to control modules corresponding to the inactive channels, and preventing supply of power to the nonvolatile memories corresponding to the inactive channels in response to an enable signal based on the calculated average number of requests.

8. A non-transitory recording medium for recording a program for executing the data mapping method of claim 1.

9. A data storage system comprising:
a nonvolatile memory device having a plurality of channels, each channel comprising a plurality of nonvolatile memories to which data input from a host are written; and
a controller configured to determine a number of active channels from among the plurality of channels based on requests from the host, to include the plurality of nonvolatile memories of the active channels as active zones in a candidate zone list, and to sequentially write data from the host only to the active zones included in the candidate zone list.

10. The data storage system of claim 9, wherein the controller is further configured to determine a number of inactive channels from among the plurality of channels based on the requests from the host, wherein the plurality of nonvolatile memories of the inactive channels are inactive zones and are not included in the candidate zone list.

11. The data storage system of claim 10, wherein the controller comprises a request queue configured to store requests from the host and to calculate an average number of requests from the host stored over a predetermined time, wherein the number of active channels is determined based on the calculated average number.

12. The data storage system of claim 11, wherein, when the calculated average number of requests is outside a predetermined reference range, the controller increases the number of the active channels and includes active zones corresponding to the increased number of the active channels to the candidate zone list.

13. The data storage system of claim 11, wherein, when the calculated average number of requests is within the predetermined reference range, the controller increases the number of the inactive channels and removes zones corresponding to the increased number of the inactive channels from the candidate zone list.

14. The data storage system of claim 11, further comprising:
a power supply controller configured to supply a synchronization signal to control modules corresponding to the active channels and not to supply the synchronization signal to control modules corresponding to the inactive channels, based on an enable signal.

15. The data storage system of claim 14, wherein the power supply controller is further configured to supply power to nonvolatile memories corresponding to the active channels and not to supply power to the nonvolatile memories corresponding to the inactive channels, based on the enable signal.

16. The data storage system of claim 15, wherein the controller further comprises a flash translation layer configured to selectively output the enable signal to control the power supply controller, based on the calculated average number of requests.

17. A data storage device comprising:
a nonvolatile memory device having a plurality of channels, each channel comprising a plurality of nonvolatile memories; and
a controller configured comprising:
a request queue configured to store requests from a host and to calculate an average number of requests from the host stored over a predetermined time at predetermined time intervals;
a processing unit configured to determine a number of active channels from among the plurality of channels based on the calculated average number of requests, and to include the plurality of nonvolatile memories of the active channels as active zones in a candidate zone list; and
a memory interface configured to interface with the nonvolatile memory device to enable data from the host to be sequentially written to the active zones included in the candidate zone list.

18. The data storage device of claim 17, wherein the memory interface comprises a plurality of control modules corresponding to the plurality of channels of the nonvolatile memory device, wherein a synchronization signal is supplied to each of the control modules corresponding to the active channels of the plurality of channels, respectively, and is not supplied to each of the control modules corresponding to inactive channels of the plurality of channels.
